(19) United States
(12) Patent Application Publication
(10) Pub. No.: US 2015/0155747 A1
(43) Pub. Date: Jun. 4, 2015

(54) MOTOR AND WASHING MACHINE HAVING THE SAME

(71) Applicant: SAMSUNG ELECTRONICS CO., LTD., Suwon-si (KR)

(72) Inventors: Jin Woo HAN, Suwon-si (KR); Deok Jin Kim, Hwaseong-si (KR); Young Kwan Kim, Anyang-si (KR); Byung Ryel In, Suwon-si (KR)

(73) Assignee: SAMSUNG ELECTRONICS CO., LTD., Suwon-si (KR)

(21) Appl. No.: 14/551,395

(22) Filed: Nov. 24, 2014

(30) Foreign Application Priority Data
Nov. 29, 2013 (KR) 10-2013-0147384

(51) Int. Cl. H02K 1/27; H02K 1/28

(52) U.S. Cl. CPC H02K 1/2773; H02K 1/28

(57) ABSTRACT

A washing machine includes a motor configured to rotate a drum, and the motor includes a stator having stator cores and coils wound around the stator cores, and a rotor configured to rotate in electromagnetic interaction with the stator. The rotor includes a plurality of rotor cores arranged spaced apart from each other in a circumferential direction of the rotor, a plurality of rotor slots formed between the plurality of rotor cores, a plurality of permanent magnets inserted into the plurality of rotor slots, and a plurality of connection members disposed outside the permanent magnets in a radial direction of the rotor and configured to connect between the plurality of rotor cores.

### CROSS-REFERENCE TO RELATED APPLICATIONS

This application claims the benefit of Korean Patent Application No. 10-2013-0147384, filed on Nov. 29, 2013 in the Korean Intellectual Property Office, the disclosure of which is incorporated herein by reference.

### BACKGROUND

1. Field

Embodiments of the present disclosure relate to a motor for generating a rotational force and a washing machine having the same.

2. Description of the Related Art

A washing machine is an apparatus configured to wash the clothing using electric power, which generally includes a tub configured to store wash water, a drum rotatably installed in the tub, and a motor configured to rotationally drive the drum.

The motor is a device configured to obtain a rotational force from electric energy, which includes a stator and a rotor. The rotor is configured to electromagnetically interact with the stator, and rotates by the force acting between a magnetic field and an electric current flowing through coils.

Permanent magnet motors using a permanent magnet to generate a magnetic field may be classified into a surface-mounted permanent magnet motor, an interior-type permanent magnet motor, and a spoke-type permanent magnet motor.

Among these, the spoke-type permanent magnet motor has a structurally high magnetic flux density, and thus has advantages in that the motor can generate high torque and high power and can be miniaturized with respect to the same power. The spoke-type permanent magnet motor is applicable to drive motors for washing machines, electric cars or small generators, all of which require high-torque and high-power characteristics.

In general, a rotor of the spoke-type permanent magnet motor includes permanent magnets disposed in a radial manner about the axis of rotation, and cores provided to support the permanent magnets and form a path for the magnetic flux.

However, such a spoke-type permanent magnet motor has problems in that the permanent magnets may break away from the rotor by means of centrifugal force generated when the rotor rotates at a high speed, or the cores may be deformed or damaged.

### SUMMARY

Therefore, it is an aspect of the present disclosure to provide a motor having an improved structure to enhance durability of the rotor, and a washing machine having the same.

Additional aspects of the disclosure will be set forth in part in the description which follows and, in part, will be apparent from the description, or may be learned by practice of the disclosure.

According to one aspect of the present disclosure, a washing machine including a motor configured to rotate a drum. Here, the motor includes a stator having stator cores and coils wound around the stator cores, and a rotor disposed inside the stator and configured to rotate in electromagnetic interaction with the stator, and the rotor includes a plurality of rotor cores arranged spaced apart from each other in a circumferential direction of the rotor, a plurality of rotor slots formed between the plurality of rotor cores, a plurality of permanent magnets inserted into the plurality of rotor slots, and a plurality of connection members disposed outside the permanent magnets in a radial direction of the rotor and configured to connect between the plurality of rotor cores.

Each of the plurality of rotor cores may include a first rotor core and a second rotor core disposed adjacent to each other with one of the plurality of permanent magnets interposed therebetween, and each of the connection members may be provided between the first rotor core and the second rotor core to connect an outer lateral end of the first rotor core to an outer lateral end of the second rotor core.

Each of the connection members may be formed integrally with each of the rotor cores.

The washing machine may include a molding member with which spaces defined by the rotor slots, the permanent magnets and the connection members are filled.

Each of the rotor cores may include at least one external support protrusion formed to support an outer lateral end of each of the permanent magnets.

The connection member may be disposed outside the external support protrusion in a radial direction of the rotor.

The connection member may be spaced apart from the external support protrusion.

The thickness of each of the connection members in the radial direction of the rotor may be in a range between greater than or equal to 0.2 mm and less than or equal to 2 mm.

The rotor may include a sleeve configured to form a shaft hole, a plurality of bridges arranged to connect the respective rotor cores to the sleeve, and a plurality of internal support protrusions configured to protrude outside from the sleeve in a radial direction to support inner lateral ends of the plurality of permanent magnets.

The plurality of internal support protrusions may be arranged between the respective bridges in a circumferential direction of the rotor.

The rotor core may include at least one accommodation groove formed between the connection members and the external support protrusion.

The sleeve may include a barrier hole configured to reduce the magnetic flux leaked through the sleeve, and the barrier holes may be formed at positions corresponding to the internal support protrusions.

The washing machine may include a molding member formed to cover an outer circumferential surface of each of the rotor cores.

According to another aspect of the present disclosure, a motor includes a stator, and a rotor rotatably disposed inside or outside the stator. Here, the rotor includes a rotor body having a sleeve configured to form a shaft hole and rotor cores connected to the sleeve and disposed in a radial manner, and permanent magnets inserted between the rotor cores, and each of the rotor cores includes a first protrusion configured to extend from a lateral surface of each of the rotor cores in a circumferential direction of the rotor to support outer lateral ends of the permanent magnets, and a second protrusion disposed outside the first protrusion in a radial direction of the rotor and configured to extend from a lateral surface of each of the rotor cores in a circumferential direction of the rotor to connect between the plurality of rotor cores.

The rotor may include a plurality of bridges arranged to connect the respective rotor cores to the sleeve, and a plurality of third protrusions configured to protrude outward from the sleeve in a radial direction to support inner lateral ends of the plurality of permanent magnets.

The motor may include a first cover plate and a second cover plate disposed at both sides of the rotor body in an axial direction of the rotor.

The motor may include at least one through hole formed to pass through each of the rotor cores in an axial direction of the rotor, and at least one coupling member configured to be inserted into the rotor body through the through hole to fix the first cover plate and the second cover plate in the rotor body.

According to still another aspect of the present disclosure, a washing machine includes a tub provided to store wash water, a drum disposed inside the tub and rotatably supported by the tub through a drive shaft, and a motor installed at a lower portion of the tub to rotate the drive shaft. Here, the motor includes a stator having stator cores and coils wound around the stator cores, a motor shaft connected to the drive shaft through a power transmission device, a rotor disposed inside the stator and coupled to the motor shaft. In this case the rotor include a sleeve having a shaft hole formed therein, a plurality of rotor cores coupled to the sleeve and arranged spaced apart from each other in a circumferential direction of the rotor to define a plurality of rotor slots, a plurality of permanent magnets inserted into the plurality of rotor slots and having inner lateral ends disposed spaced apart from the sleeve, a plurality of connection members configured to connect outer lateral ends of the plurality of rotor cores, and a molding member with which spaces defined by the rotor slots, the permanent magnets and the connection members are filled.

The rotor may include at least one through hole formed to pass through each the rotor cores in an axial direction of the rotor, and the through hole may be filled with the molding member.

The rotor may include a plurality of bridges arranged to connect the respective rotor cores to the sleeve, and spaces defined by the sleeve, the permanent magnets and the bridges may be filled with the molding member.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a diagram showing the configuration of a washing machine according to one embodiment of the present disclosure;

FIG. 2 is a diagram showing the configuration of a motor according to one embodiment of the present disclosure;

FIG. 3 is a perspective view showing a stator in the motor according to one embodiment of the present disclosure;

FIG. 4 is a perspective view showing a rotor according to one embodiment of the present disclosure;

FIG. 5 is an exploded perspective view showing the rotor according to one embodiment of the present disclosure;

FIG. 6 is a diagram showing the configuration of the stator and the rotor in the motor according to one embodiment of the present disclosure;

FIG. 7 is an enlarged view showing a portion of the rotor according to one embodiment of the present disclosure;

FIG. 8 is a perspective view showing a rotor according to another embodiment of the present disclosure; and

FIG. 9 is an enlarged view showing a portion of the rotor according to another embodiment of the present disclosure.

### DETAILED DESCRIPTION

Reference will now be made in detail to the embodiments of the present disclosure, examples of which are illustrated in the accompanying drawings, wherein like reference numerals refer to like elements throughout.

Hereinafter, preferred embodiments of the present disclosure will be described in further detail with reference to the accompanying drawings. In the following description, an axial direction X refers to a direction parallel to a motor shaft. A circumferential direction C and a radial direction R refer to a circumferential direction and a radial direction of a circle from a motor shaft.

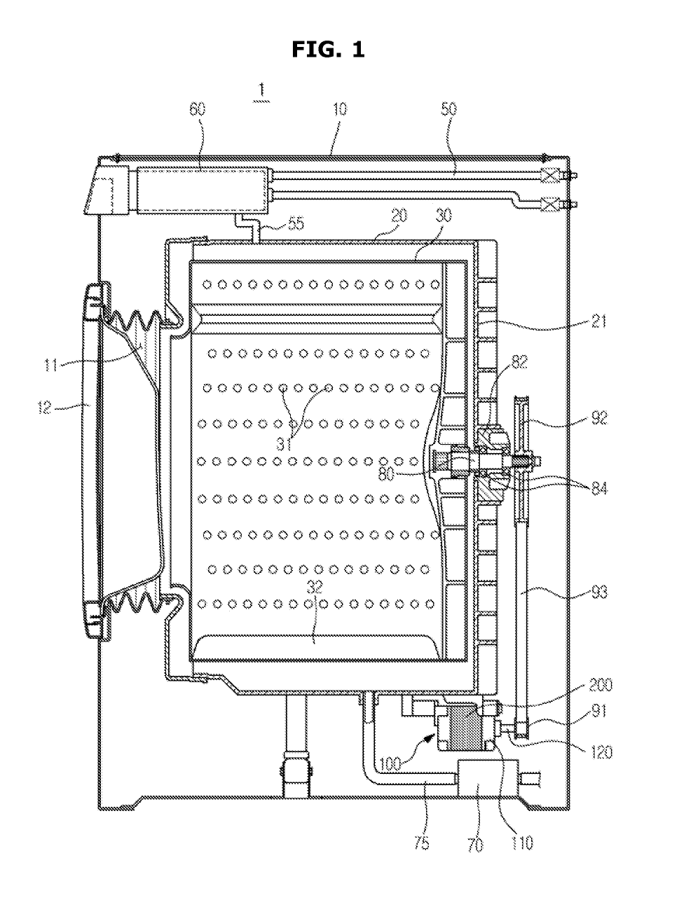

As shown in FIG. 1, the washing machine 1 includes a cabinet 10 configured to form the appearance thereof, a tub 20 disposed inside the cabinet 10 to store water, a drum 30 rotatably disposed inside the tub 20, and a drive motor 100 configured to drive the drum 30.

An input hole 11 is formed at a front surface of the cabinet 10 to input the dirt washing into the drum 30. The input hole 11 is opened/closed by a door 12 installed at the front surface of the cabinet 10.

A water pipe 50 is installed at an upper portion of the tub 20 to supply wash water into the tub 20. One side of the water pipe 50 is connected to an external water source (not shown), and the other side of the water pipe 50 is connected to a detergent feeding unit 60. The detergent feeding unit 60 is connected to the tub 20 via a connection tube 55. Water supplied through the water pipe 50 is supplied into the tub 20 together with a detergent via the detergent feeding unit 60.

A drain pump 70 and a drainage pipe 75 configured to drain water in the tub 20 out of the cabinet 10 is installed at a lower portion of the tub 20.

A plurality of through holes 31 configured to circulate wash water are formed around the drum 30, and a lifter 32 is installed at an inner circumferential surface of the drum 30 to achieve the rise and drop of the dirty clothing while rotating the drum 30.

A drive shaft 80 is coupled to the drum 30. In this case, the drive shaft 80 is rotatably supported by the tub 20. One end of the drive shaft 80 is passed through a rear wall 21 of the tub 20 to extend to the outside of the tub 20.

A bearing housing 82 is installed at a rear wall 21 of the tub 20 to rotatably support the drive shaft 80. The bearing housing 82 may be formed of an aluminum alloy, and may be inserted into the rear wall 21 of the tub 20 when the tub 20 is molded by injection. Bearings 84 are installed between the bearing housing 82 and the drive shaft 80 to smoothly rotate the drive shaft 80.

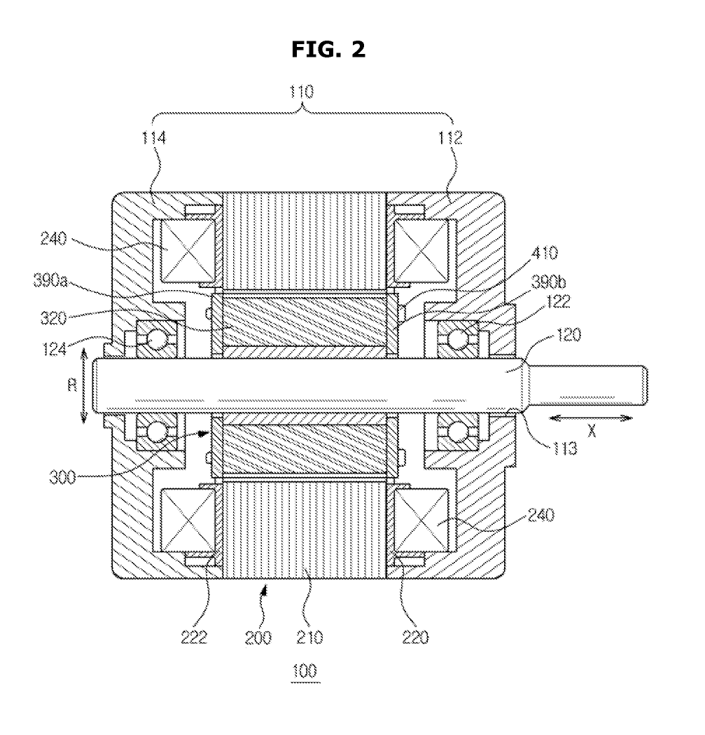

The drive motor 100 is mounted at a lower portion of the tub 20. The drive motor 100 includes a motor housing 110, a stator 200 fixed in the motor housing 110, and a rotor 300 disposed inside the stator 200 (see FIG. 2).

A motor pulley 91 is installed at an end of a motor shaft 120 protruding outward from the motor housing 110, and a drum pulley 92 is installed at the drive shaft 40 connected to the drum 30. The motor pulley 91 and the drum pulley 92 may be coupled to each other by means of a belt 93. The motor pulley 91, the drum pulley 92 and the belt 93 belong to a power transmission device configured to transmit the power of the motor 100 to the drive shaft 80 of the drum 30.

Hereinafter, the configuration of the drive motor 100 will be described in further detail.

As shown in FIG. 2, the motor 100 includes a motor housing 110 configured to form the appearance of the motor 100. The motor housing 110 may be composed of a first housing 112 and a second housing 114, which are separated in an axial direction of the motor 100. The first housing 112 and the second housing 114 may be coupled to the stator 200.

The stator 200 and the rotor 300 are arranged inside the motor housing 110. The stator 200 may be fixed in the motor housing 110. The rotor 300 is configured to rotate in electromagnetic interaction with the stator 200. The rotor 300 may be arranged inside the stator 200.

The motor shaft 120 is inserted into the rotor 300 to rotate along with the rotor 300. One side of the motor shaft 120 is rotatably supported by the first housing 112 via a bearing 122, and the other side of the motor shaft 120 is rotatably supported by the second housing 114 via a bearing 124. One lateral end of the motor shaft 120 extrudes outside from the motor housing 110 through an aperture 113 formed at the first housing 112.

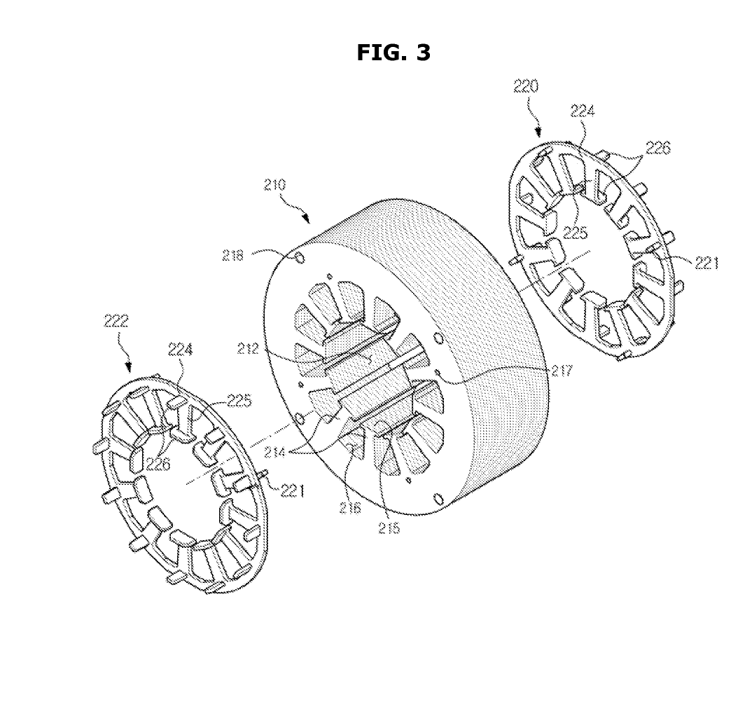

As shown in FIGS. 2, 3 and 6, the stator 200 may configured to include a stator body 210, a first insulator 220, a second insulator 222, and a coil 240. The coil 240 is omitted in FIG. 3.

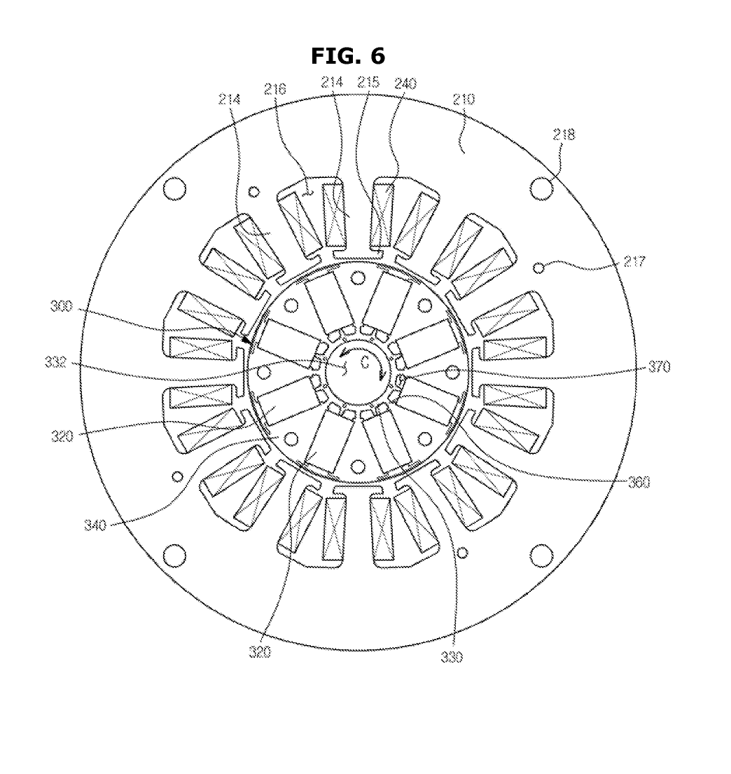

A rotor accommodation unit 212 configured to accommodate the rotor 300 is formed at a central portion of the stator body 210. Stator cores 214 are arranged around the rotor accommodation unit 212 in a circumferential direction (a direction C, see FIG. 6) of the rotor 300. The stator cores 214 extend radially from the rotor accommodation unit 212. The stator body 210 may be formed by staking press-processed iron plates.

The stator cores 214 are disposed at predetermined intervals in a circumferential direction, such that stator slots 216 are formed between the stator cores 214. As the coil 240 is wound around the stator cores 214, the coil 240 is accommodated into the stator slots 216. An expansion core unit 215 in which a portion of each of the stator cores 214 partially expands in a width direction is formed at an inner lateral end of each of the stator cores 214 adjacent to the rotor 300. A gap for rotation of the rotor 300 is formed between an inner surface of the expansion core unit 215 and an outer surface of the rotor 300.

The first insulator 220 and the second insulator 222 are formed of a material having electrical insulating properties, and disposed respectively at both sides of the stator body 210 in an axial direction. The first insulator 220 and the second insulator 222 are coupled respectively to both sides of the stator body 210 to cover the stator cores 214. Coupling protrusions 221 protruding toward the stator body 210 are formed at the first insulator 220 and the second insulator 222. In this case, the coupling protrusions 221 are inserted into coupling holes 217 formed at the stator body 210.

Each of the first insulator 220 and the second insulator 222 includes a ring-shaped flange 224, coil supporting portions 225 arranged to correspond to the stator cores 214, and coil guiding portions 226 configured to protrude inward and outward the coil supporting portions 225 in a radial direction. The coil supporting portions 225 are spaced apart in a circumferential direction so that spaces corresponding to the stator slots 216 are formed between the coil supporting portions 225.

The coil 240 is wound around the stator core 214 and the coil supporting portions 225 of the first and second insulators 220 and 222 in a state in which the first insulator 220 and the second insulator 222 are coupled to the stator body 210.

Insertion holes 218 passing through the stator body 210 in an axial direction may be formed at the stator body 210. Coupling members (not shown), such as pins, rivets or bolts, configured to couple each of plates constituting the stator body 210 are inserted into the insertion holes 218.

Housing through holes (not shown) may be formed at the first housing 112 and the second housing 114 to correspond to the insertion holes 218 of the stator body 210 so that the first housing 112, the second housing 114 and the stator 200 can be fixed by one coupling member.

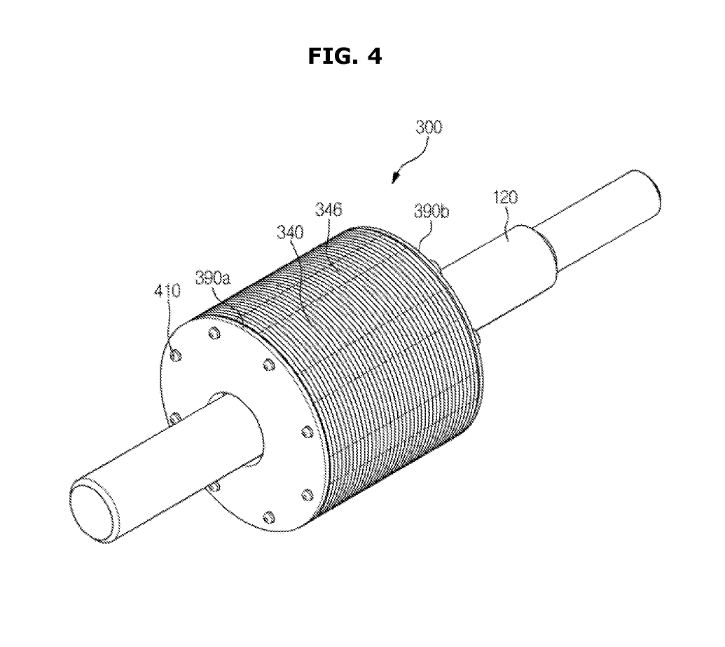

As shown in FIGS. 4 to 7, the rotor 300 includes a rotor body 310 disposed at the rotor accommodation unit 212 of the stator body 210, and permanent magnets 320 inserted into the rotor body 310. The rotor body 310 may be formed by stacking boards, each of which is formed by press-processing a silicon steel plate.

A first cover plate 390a and a second cover plate 390b may be disposed at both sides of the rotor body 310 in an axial direction (direction X), respectively, to reinforce the structural hardness of the rotor 300. A shafting hole 392 is formed at the center of each of the first cover plate 390a and the second cover plate 390b to accommodate the motor shaft 120.

The first and second cover plates 390a and 390b are disposed in an axial direction to cover the outer sides of the permanent magnets 320 in order to prevent the permanent magnets 320 from breaking away from the rotor 300 in an axial direction. Also, the first and second cover plates 390a and 390b may be used as structures configured to keep balance in the rotor 300 when there is an imbalance in the rotor 300. The first and second cover plates 390a and 390b may be formed of a non-magnetic material, for example, copper or stainless steel.

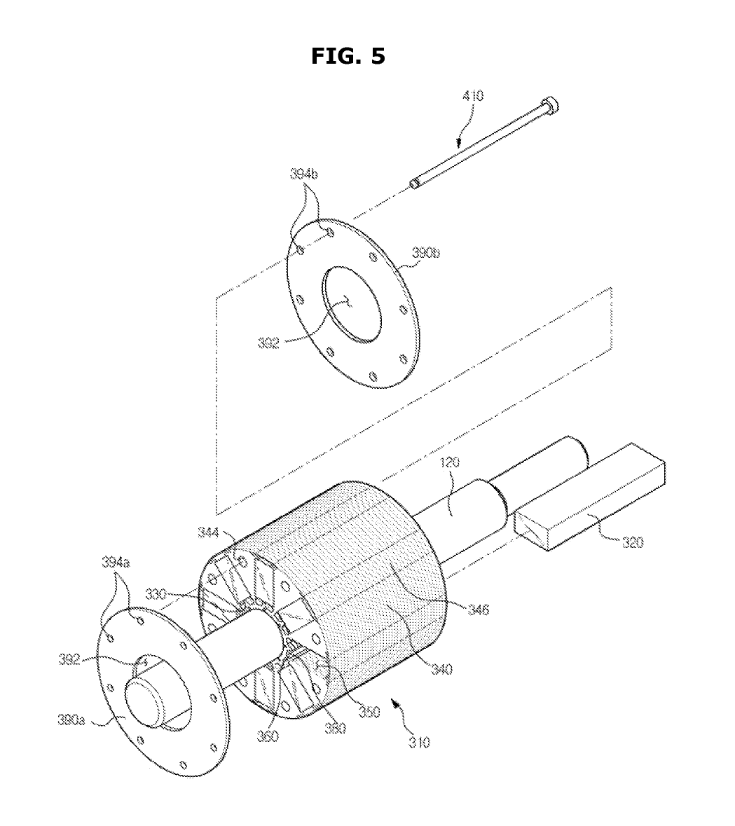

The permanent magnets 320 are arranged in a circumferential direction of the rotor 300 so that the permanent magnets 320 are arranged radially from the motor shaft 120. FIG. 5 shows one example in which 8 permanent magnets are arranged, but the number of the permanent magnets may vary. Each of the permanent magnets may include a ferrite magnet or a magnet including a rare earth element such as neodymium or samarium.

Inner lateral ends 321 of the permanent magnets 320 are disposed adjacent to the motor shaft 120 in a radial direction of the rotor 300, and outer lateral ends 322 of the permanent magnets 320 are disposed adjacent to the stator 200. The inner lateral end 321 and the outer lateral end 322 of each of the permanent magnets 320 include short sides 323 and 324 extending in a circumferential direction of the rotor 300. The short sides 323 and 324 of each of the permanent magnets 320 are coupled to long sides 325 and 326 extending in a radial direction of the rotor 300. The long sides 325 and 326 of each of the permanent magnets 320 have a larger length than the short sides 323 and 324 of each of the permanent magnets 320.

The north (N) and south (S) poles of the permanent magnets 320 are arranged in a circumferential direction of the rotor 300. A first permanent magnet 320a and a second permanent magnet 320b adjacent to each other in the permanent magnets 320 are disposed so that the same polarities face each other. In such a magnetic circuit, the magnetic flux generated in a permanent magnet may be concentrated, thereby improving performance while reducing the size of the motor.

The rotor body 310 includes a sleeve 330 configured to form a shaft hole 332 to which the motor shaft 120 is able to be inserted, and rotor cores 340 coupled to the sleeve 330.

The sleeve 330 is formed in a ring shape, and has an inner circumference 334 coming in contact with the motor shaft 120 inserted into the shaft hole 332, and an outer circumference 336 facing the permanent magnets 320 inserted into the rotor body 310.

The thickness t between the inner circumference 334 and the outer circumference 336 of the sleeve 330 may be greater than or equal to 1.0 mm, and less than or equal to 3.0 mm. When the thickness t is greater than 3.0 mm, the performance of the motor may be deteriorated due to an excessive increase in magnetic flux leaked from the rotor cores 340 to the sleeve 330. On the other hand, when the thickness t is less than 1.0 mm, a structural problem in which the sleeve 330 is deformed when the motor shaft 120 is press-fit into the shaft hole 332 may occur.

The rotor cores 340 support the permanent magnets 320 and form a path (magnetic path) for the magnetic flux generated from the permanent magnets 320. The rotor cores 340 are arranged in a circumferential direction of the rotor 300, and disposed spaced apart from each other to form rotor slots 350 configured to accommodate the permanent magnets 320.

The rotor cores 340 may be coupled to the sleeve 330 via bridges 360. The bridges 360 are arranged in a circumferential direction of the rotor 300, respectively, to correspond to the rotor cores 340. The bridges 360 may extend outside from the outer circumference 336 of the sleeve 330 in a radial direction to be coupled to inner lateral ends of the corresponding rotor cores 340.

The bridges 360 preferably have a width W1 of 1.0 mm or less. The width W1 of the bridges 360 has an influence on an amount of the magnetic flux leaked toward the sleeve 330 via the bridges 360. In this case, as the width W1 of the bridges 360 gets narrow, an increase in magnetic resistance may be caused, resulting in a reduction in the leaked magnetic flux.

However, the bridges 360 are structures configured to connect the rotor cores 340 to the sleeve 330. When the width W1 of the bridges 360 is highly narrowed, the bridges 360 may be damaged or the rotor body 310 may be deformed upon high-speed rotation of the rotor 300. Therefore, the width W1 of the bridges 360 is preferably greater than or equal to 0.4 mm to maintain structural strength.

The permanent magnets 320 are accommodated into the rotor slots 350, each of which is defined between the two adjacent rotor cores 340. The permanent magnets 320 are disposed spaced apart from the sleeve 330 to form inner spaces 370 between the permanent magnets 320 and the sleeve 330 (see FIG. 6). The magnetic flux of the permanent magnets 320 may be effectively inhibited from being leaked toward the motor shaft 120 via the sleeve 330 due to the presence of such inner spaces 370.

The inner spaces 370 between the permanent magnets 320 and the sleeve 330 may be filled with a molding member 400. The flux of the permanent magnets 320 may be prevented by the molding member 400 filled into the inner spaces 370, and structural strength and stability of the rotor 300 may be improved.

The outer lateral ends 322 of the permanent magnets 320 are arranged at an inner position than the outer lateral ends of the rotor cores 340 in a radial direction of the rotor 300. External support protrusions 341 protruding toward the two adjacent rotor slots 350 are provided at outer lateral ends of the rotor cores 340. Both edges of each of the outer lateral ends 322 of the permanent magnets 320 are supported by the external support protrusions 341 protruding from the two adjacent rotor cores 340.

The thickness t1 of the external support protrusions 341 in a radial direction of the rotor 300 is preferably greater than or equal to 0.5 mm and less than or equal to 2 mm. When the external support protrusions 341 are extremely thin with a thickness t1 of less than 0.5 mm, the external support protrusions 341 may be deformed or damaged by the centrifugal force upon high-speed rotation of the rotor 300, and thus the permanent magnets 320 may break away from the rotor slots 350. On the other hand, when the external support protrusions 341 are extremely thick with a thickness t1 of greater than 2 mm, the radius of rotor 300 may unnecessarily increase, which makes it difficult to miniaturize the motor.

The two adjacent rotor cores 340 disposed at both side of one of the permanent magnets 320 are coupled to each other via the connection member 346. The connection member 346 may be made of the same material as the rotor cores 340, and formed integrally with the rotor cores 340. The connection member 346 is provided in the form of protrusions extending from the lateral surfaces of the rotor core 340s in a circumferential direction C of the rotor 300 to connect between the rotor cores 340.

The connection member 346 is disposed outside the permanent magnets 320 and the external support protrusions 341 in a radial direction of the rotor 300, and spaced apart from the external support protrusions 341.

The connection member 346 connects the outer lateral ends of the two adjacent rotor cores 340. Therefore, open sides of the rotor slots 350, that is, spaces 352 defined by the two rotor cores 340 adjacent in a circumferential direction of the rotor 300 and the outer lateral ends 322 of the permanent magnets 320 are closed by the connection member 346.

The connection member 346 reinforces the structural strength of the rotor 300. Therefore, the deformation of the rotor cores 340 or the breakaway of the permanent magnets 320 from the rotor slots 350 caused by the centrifugal force upon high-speed rotation of the rotor 300 may be stably prevented.

The thickness t2 of the connection member 346 in a radial direction R of the rotor 300 is preferably greater than or equal to 0.2 mm and less than or equal to 2 mm. When the connection member 346 is extremely thin with a thickness t2 of less than 0.2 mm, an effect of reinforcing the strength of the rotor 300 may be insignificant, and it is difficult to form the connection member 346. On the other hand, when the connection member 346 is extremely thick with a thickness t2 of greater than 2 mm, the efficiency of the motor may be deteriorated due to an increase in the magnetic flux leaked via the connection member 346.

An inner space 352 (hereinafter referred to as a ‘molding member accommodation unit’) formed by the two adjacent rotor cores 340, the outer lateral end 322 of each of the permanent magnets 320 and the connection member 346 may be filled with the molding member 400. The molding member 400 filled into the molding member accommodation unit 352 supports the outer lateral ends 322 of the permanent magnets 320 with the external support protrusions 341, thereby reinforcing the structural strength of the rotor 300. Therefore, the deformation of the external support protrusions 341 and the breakaway of the permanent magnets 320 from the rotor slot 350 caused by the centrifugal force upon high-speed rotation of the rotor 300 may be prevented.

An accommodation groove 343 is formed between the external support protrusion 341 and the connection member 346. The accommodation groove 343 is filled with some of the molding member 400 accommodated into the molding member accommodation unit 352, and the molding member 400 in the accommodation groove 343 is supported by the connection member 346 disposed outside the molding member 400. Therefore, the breakaway of the molding member 400 from the molding member accommodation unit 352 caused by the centrifugal force upon high-speed rotation of the rotor 300 may be prevented.

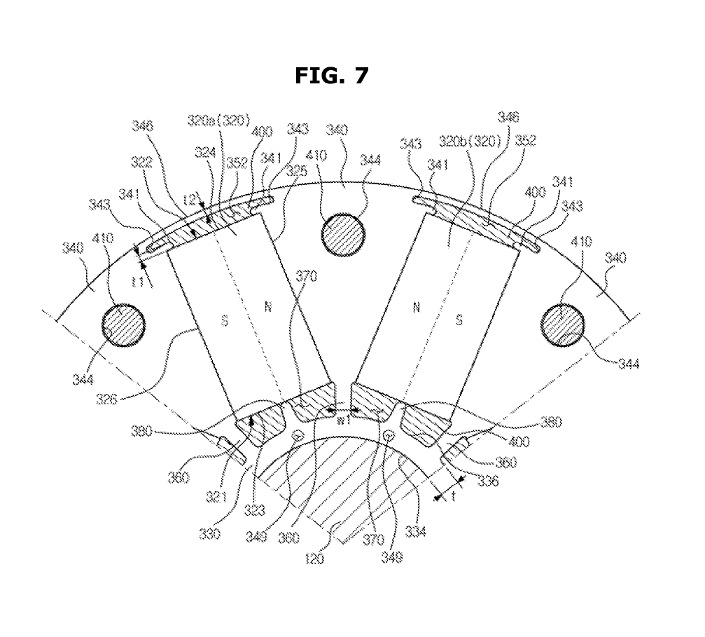

As shown in FIG. 7, the rotor body 310 includes internal support protrusions 380 configured to support the inner lateral ends 321 of the permanent magnets 320 so that the permanent magnets 320 are spaced apart from the sleeve 330. The internal support protrusions 380 are disposed respectively to correspond to the permanent magnets 320, and protrude outside from the outer circumference 336 of the sleeve 330 in a radial direction. The sleeve 330, the rotor cores 340, the bridges 360 and the internal support protrusions 380 may be made of the same material and formed integrally to form the rotor body 310.

The internal support protrusions 380 are arranged between the bridges 360 in a circumferential direction of the rotor 300. In this case, each of the internal support protrusions 380 is disposed spaced apart from the two adjacent bridges 360. Also, each of the internal support protrusions 380 is formed to be separated from the two adjacent bridges 360.

When the structure configured to support the permanent magnets 320 is formed integrally with the bridges, an increase in the magnetic flux leaked toward the motor shaft may be caused due to an increase in width of the bridges. As shown in FIG. 7, however, when the internal support protrusions 380 are separately formed to be separated from the bridges 360, the width of the bridges 360 may be reduced, resulting in a decrease in the leaked magnetic flux.

When the internal support protrusions 380 are disposed near the bridges 360, the magnetic flux leaked toward the sleeve 330 via the internal support protrusions 380 may increase although the internal support protrusions 380 are separated from the bridges 360. Therefore, the internal support protrusions 380 may be disposed at the central portion of the inner space 370 in a circumferential direction of the rotor 300 so that the internal support protrusions 380 are disposed as far as possible from the two adjacent bridges 360. Also, each of the bridges 360 may be disposed at the center between the two adjacent bridges 360.

The internal support protrusions 380 may be disposed to support the central portions of the inner lateral ends 321 of the permanent magnets 320. As a result, the permanent magnets may be stably supported even when one internal support protrusion may support the inner lateral ends of the permanent magnets 320. Also, the central portion of each of the inner lateral ends 321 of the permanent magnets 320 corresponds to a contact surface between the N and S poles of each of the permanent magnets 320. In this case, when the one internal support protrusion 380 is configured to support such a contact surface, the magnetic flux leaked via the internal support protrusion 380 may be reduced.

As shown in FIG. 7, barrier holes 349 configured to reduce the magnetic flux leaked via the sleeve 330 is formed at the sleeve 330. The barrier holes 349 are formed at positions corresponding to the internal support protrusions 380 so that the width of a magnetic path gets small at a region in which each of the internal support protrusions 380 is formed. The sections of the barrier holes 349 may be in a circular or oval shape.

The first cover plate 390a and the second cover plate 390b are disposed at both side of the rotor body 310 in an axial direction X of the rotor 300. The rotor body 310 and the first and second cover plates 390a and 390b are fixed by means of the coupling member 410. The rotor body 310 is configured to include through holes 344 passing through the rotor cores 340 in an axial direction. The through holes 344 may be provided in at least one of the rotor cores 340. FIGS. 1 to 7 show examples in which the through holes 344 are formed respectively to correspond to the rotor cores 340.

The first plate hole 394a and the second plate hole 394b may be formed at the first and second cover plates 390a and 390b, respectively, to correspond to the through holes 344 formed at the rotor cores 340.

The first and second cover plates 390a and 390b may be disposed at both sides of the rotor body 310, and the coupling member 410 may be inserted into the second plate hole 394b, the through holes 344 and the first plate hole 394a to integrate the first and second cover plates 390a and 390b into the rotor body 310, thereby reinforcing the structural strength of the rotor 300.

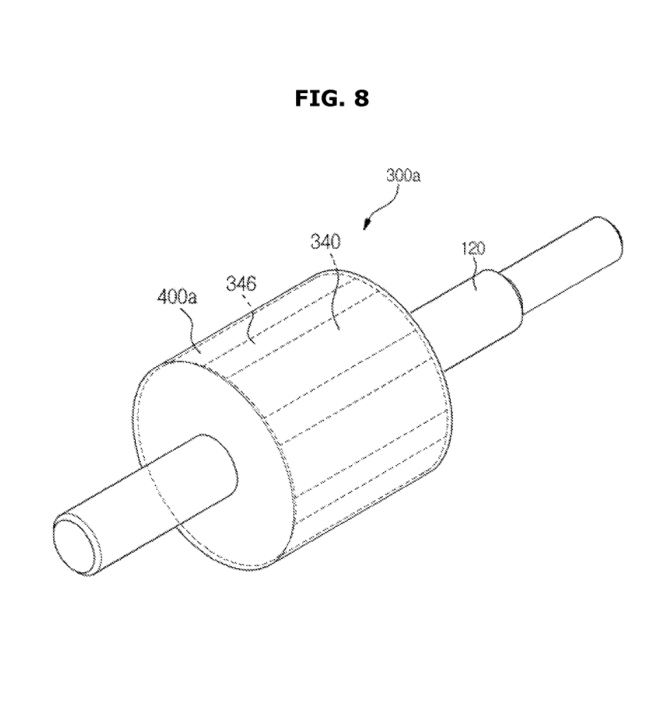

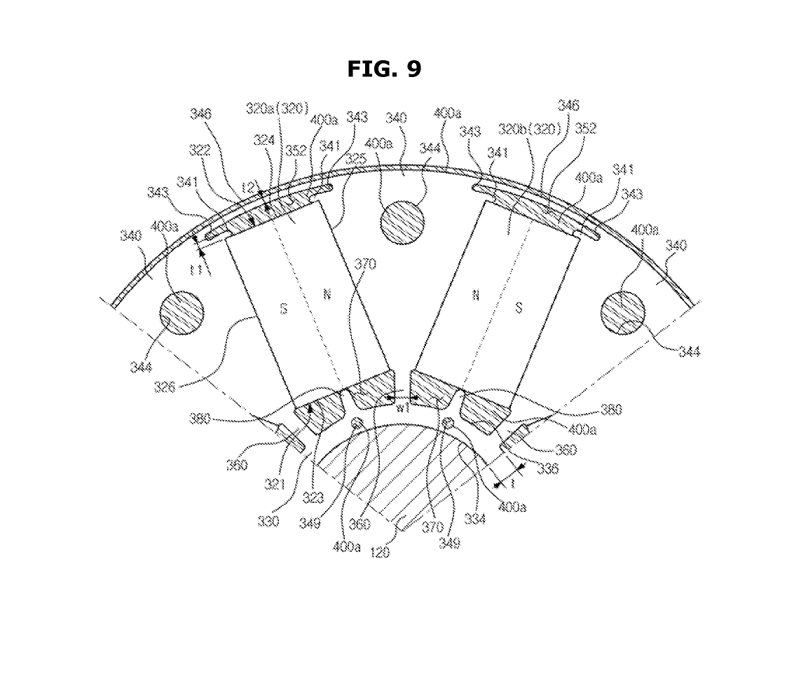

As shown in FIGS. 8 and 9, the strength of a rotor 300a may be reinforced using a molding member 400a formed by insert molding.

When the rotor body 310 is inserted into a mold (not shown) and injection-molded with a resin material in a state in which the permanent magnets 320 are coupled to the rotor body 310, the inner spaces 370 between the permanent magnets 320 and the sleeve 330, the barrier holes 349, the through holes 344, and the molding member accommodation units 352 are filled with a molding member 400a. Also, the molding member 400a is formed to cover the entire rotor body 310. That is, the outer circumferential surfaces of the rotor cores 340 and both sides of the rotor body 310 are covered by the molding member 400a. Such a molding member 400a is a non-magnetic material, and functions to inhibit the magnetic flux of the permanent magnets 320 from being leaked to the sleeve 330 and further improve the structural stability of the rotor 300a together with the connection member 346 as well.

As described above, the motor 100 is applicable to clothing dryers, air conditioners, refrigerators, compressors, and electric cars requiring a miniaturized high-power motor, as well as the washing machine.

Since the rotor has an improved structural strength, the breakaway of the permanent magnet from the rotor or the damage of the rotor cores caused upon high-speed rotation of the rotor may be prevented.

Although a few embodiments of the present disclosure have been shown and described, it would be appreciated by those skilled in the art that changes may be made in these embodiments without departing from the principles and spirit of the invention, the scope of which is defined in the claims and their equivalents.

What is claimed is:

1. A washing machine comprising a motor configured to rotate a drum, wherein the motor comprises:
a stator having stator cores and coils wound around the stator cores; and
a rotor disposed inside the stator and configured to rotate in electromagnetic interaction with the stator, and
the rotor comprises
a plurality of rotor cores arranged spaced apart from each other in a circumferential direction of the rotor;
a plurality of rotor slots formed between the plurality of rotor cores;
a plurality of permanent magnets inserted into the plurality of rotor slots; and
a plurality of connection members disposed outside the permanent magnets in a radial direction of the rotor and configured to connect between the plurality of rotor cores.

2. The washing machine of claim 1, wherein:
each of the plurality of rotor cores comprises a first rotor core and a second rotor core disposed adjacent to each other with one of the plurality of permanent magnets interposed therebetween, and
each of the connection members is provided between the first rotor core and the second rotor core to connect an outer lateral end of the first rotor core to an outer lateral end of the second rotor core.

3. The washing machine of claim 1, wherein each of the connection members is formed integrally with each of the rotor cores.

4. The washing machine of claim 1, comprising a molding member with which spaces defined by the rotor slots, the permanent magnets and the connection members are filled.

5. The washing machine of claim 1, wherein each of the rotor cores comprises at least one external support protrusion formed to support an outer lateral end of each of the permanent magnets.

6. The washing machine of claim 5, wherein the connection members are disposed outside the external support protrusion in a radial direction of the rotor.

7. The washing machine of claim 5, wherein the connection members are spaced apart from the external support protrusion.

8. The washing machine of claim 1, wherein the thickness of each of the connection members in the radial direction of the rotor is in a range between greater than or equal to 0.2 mm and less than or equal to 2 mm.

9. The washing machine of claim 1, wherein the rotor comprises:
a sleeve configured to form a shaft hole;
a plurality of bridges arranged to connect the respective rotor cores to the sleeve; and
a plurality of internal support protrusions configured to protrude outside from the sleeve in a radial direction to support inner ends of the plurality of permanent magnets.

10. The washing machine of claim 9, wherein the plurality of internal support protrusions are arranged between the respective bridges in a circumferential direction of the rotor.

11. The washing machine of claim 5, wherein each of the rotor cores comprises at least one accommodation groove formed between the connection members and the external support protrusion.

12. The washing machine of claim 9, wherein:
the sleeve comprises a barrier hole configured to reduce the magnetic flux leaked through the sleeve, and
the barrier holes are formed at positions corresponding to the internal support protrusions.

13. The washing machine of claim 1, comprising a molding member formed to cover an outer circumferential surface of each of the rotor cores.

14. A motor comprising:
a stator; and
a rotor rotatably disposed inside or outside the stator,
wherein the rotor comprises
a rotor body having a sleeve configured to form a shaft hole, and rotor cores connected to the sleeve and disposed in a radial manner; and
permanent magnets inserted between the rotor cores, and each of the rotor cores comprises
a first protrusion configured to extend from a lateral surface of each of the rotor cores in a circumferential direction of the rotor to support outer lateral ends of the permanent magnets; and
a second protrusion disposed outside the first protrusion in a radial direction of the rotor and configured to extend from a lateral surface of each of the rotor cores in a circumferential direction of the rotor to connect between the plurality of rotor cores.

15. The motor of claim 14, wherein the rotor further comprises:
a plurality of bridges arranged to connect the respective rotor cores to the sleeve; and
a plurality of third protrusions configured to protrude outward from the sleeve in a radial direction to support inner lateral ends of the plurality of permanent magnets.

16. The motor of claim 14, further comprising a first cover plate and a second cover plate disposed at both sides of the rotor body in an axial direction of the rotor.

17. The motor of claim 16, further comprising:
at least one through hole formed to pass through each of the rotor cores in an axial direction of the rotor; and
at least one coupling member configured to be inserted into the rotor body through the through hole to fix the first cover plate and the second cover plate in the rotor body.

18. A washing machine comprising:
a tub provided to store wash water;
a drum disposed inside the tub and rotatably supported by the tub through a drive shaft; and
a motor installed at a lower portion of the tub to rotate the drive shaft,
wherein the motor comprises
a stator having stator cores and coils wound around the stator cores;
a motor shaft connected to the drive shaft through a power transmission device; and
a rotor disposed inside the stator and coupled to the motor shaft, the rotor comprising:
a sleeve having a shaft hole formed therein;
a plurality of rotor cores coupled to the sleeve and arranged spaced apart from each other in a circumferential direction of the rotor to define a plurality of rotor slots;
a plurality of permanent magnets inserted into the plurality of rotor slots and having inner lateral ends disposed spaced apart from the sleeve;
a plurality of connection members configured to connect outer lateral ends of the plurality of rotor cores; and
a molding member with which spaces defined by the rotor slots, the permanent magnets and the connection members are filled.

19. The washing machine of claim 18, wherein:
the rotor comprises at least one through hole formed to pass through each of the rotor cores in an axial direction of the rotor, and
the through hole is filled with the molding member.

20. The washing machine of claim 18, wherein:
the rotor comprises a plurality of bridges arranged to connect the respective rotor cores to the sleeve, and
spaces defined by the sleeve, the permanent magnets and the bridges are filled with the molding member.
